(19) United States
(12) Patent Application Publication
(10) Pub. No.: US 2015/0261406 A1
(43) Pub. Date: Sep. 17, 2015

(54) DEVICE AND METHOD FOR UNLOCKING ELECTRONIC DEVICE

(71) Applicants: SHENZHEN FUTAIHONG PRECISION INDUSTRY CO.,LTD., Shenzhen (CN); Chiun Mai Communication Systems, Inc., New Taipei (TW)

(72) Inventor: FU-BAO NIE, Shenzhen (CN)

(21) Appl. No.: 14/564,803

(22) Filed: Dec. 9, 2014

(30) Foreign Application Priority Data
Mar. 17, 2014 (CN) 201410098270.0

(51) Int. Cl. G06F 3/0488; G06F 3/0484; H04M 1/725

(52) U.S. Cl. CPC G06F 3/0488; H04M 1/72577; G06F 3/0484

(57) ABSTRACT

A method for unlocking an electronic device is disclosed. The method includes: configuring, at the electronic device, a gesture password; storing, at the electronic device, the gesture password; detecting, at the electronic device, gestures on a touch screen of the electronic device when the electronic device is in a locked state; determining, at the electronic device, whether the detected gestures are consistent with the gesture password stored in the electronic device; and unlocking the electronic device if the detected gestures are consistent with the gesture password stored in the electronic device.

### FIELD

The subject matter herein generally relates to a method and device for locking an electronic device.

### BACKGROUND

Electronic devices, for example, smart phones, portable PCs, tablet PCs, have been used with increasing popularity worldwide for a variety of personal and business uses. Users often have some personal data stored in the electronic devices and don't want others to see the personal data. Therefore, users need to lock the electronic devices when the electronic devices are put aside and unlock the electronic devices are in use.

### BRIEF DESCRIPTION OF THE DRAWINGS

Implementations of the present technology will now be described, by way of example only, with reference to the attached figures.

FIG. 1 is a diagrammatic view of an exemplary embodiment of an electronic device.

FIG. 2 is a flowchart of an exemplary embodiment of a method for unlocking the electronic device.

FIG. 3 is a diagrammatic view of an exemplary embodiment of gestures.

FIG. 4 is a diagrammatic view of an exemplary embodiment of track of gestures.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

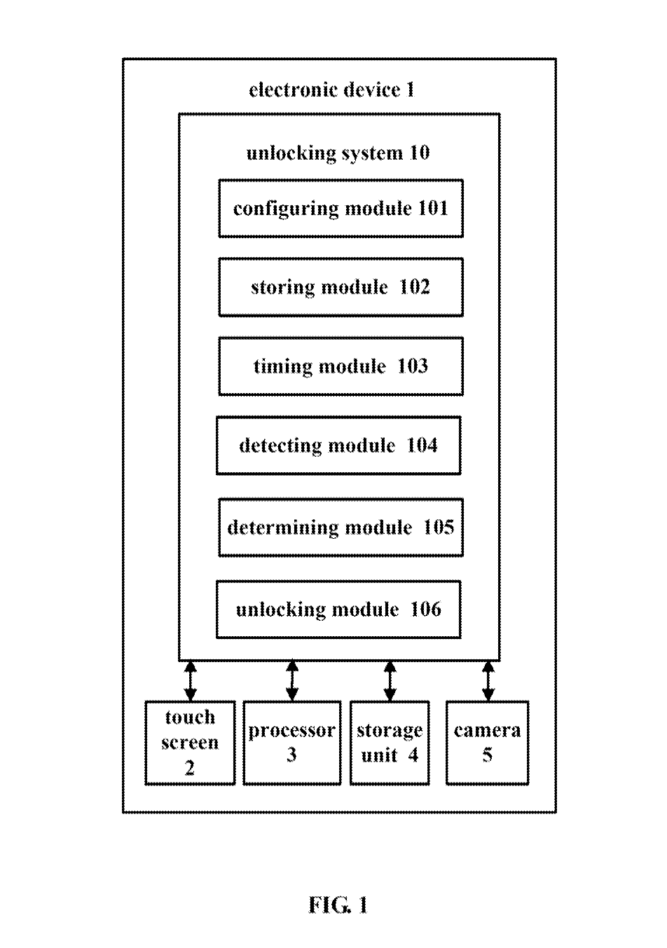

FIG. 1 illustrates a diagrammatic view of an exemplary embodiment of an electronic device 1. In the example embodiment, the electronic device 1 can be a smart phone, a portable computer, a tablet PC, or other electronic device capable of storing user data. The electronic device 1 can include, but not limited to, a touch screen 2, a processor 3, a storing unit 4, and a camera 5. The touch screen 2 can be configured to obtain touch events on the touch screen 2. The touch events can include a click on the touch screen, continuous clicks on the touch screen, or a motion on the touch screen. The processor 3 can be a central processing unit (CPU), a microprocessor, or other data processor chip that performs functions of the electronic device 1. The storage unit 4 can be a storage system, such as a hard disk, a storage card, or a data storage medium. In at least one embodiment, the storage unit 20 can include two or more storage devices such that one storage device is a memory and the other storage device is a hard drive. Additionally, one or more of the storage devices can be located external relative to the electronic device 1. The camera 5 can be configured to capture images of gestures .

An unlocking system 10 can include computerized instructions in the form of one or more programs that are executed by the processor 3 and stored in the storage unit 4. The system 10 can include one or more modules, for example, a configuring module 101, a storing module 102, a timing module 103, a detecting module 104, a determining module 105, and an unlocking module 106. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The configuring module 101 can be configured to configure one or more gestures as a gestures password. In at least one embodiment, the gestures password can include, but not limited to, one or more static gestures, duration of each static gestures, motion tail of each static gestures, and chronological order of each static gestures. The storing module 102 can be configured to encrypt the gesture password and then stored the encrypted gesture password into the storage unit 4. The timing module 103 can be configured to time duration of a gesture password. The detecting module 104 can be configured to detect gestures on the touch screen 2 when the electronic device is in a locked state. In at least one embodiment, the detecting module 104 further can be configured to detect gestures on the touch screen 2 when a user wants to configure a gesture password. The determining module 105 can be configured to determine whether detected gestures are substantially consistent with the gesture password stored in the storage unit 4. The unlocking module 106 can be configured to unlock the electronic device if the detected gestures are substantially consistent with the gesture password stored in the storage unit 4.

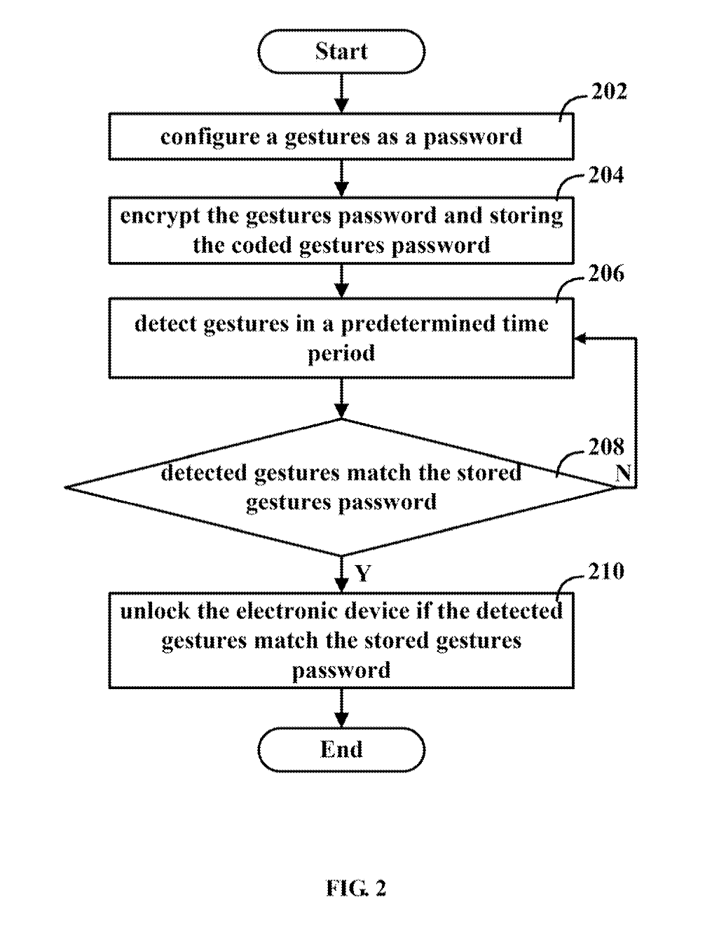

Referring to FIG. 2, a flowchart is presented in accordance with an example embodiment which is being thus illustrated. The example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 2 represents one or more processes, methods or subroutines, carried out in the exemplary method 200. Furthermore, the illustrated order of blocks is by example only and the order of the blocks can change according to the present disclosure. Additional blocks may be added or fewer blocks may be utilized, without departing from this disclosure. The exemplary method 200 for unlocking an electronic device is illustrated in FIG. 2. The exemplary method 200 can begin at block 202.

At block 202, the electronic device configures gestures as a password. The gestures can be one or more motion of a hand or a part of the hand. In detail, a camera of the electronic device captures images of gestures within a predetermined time period, for example, 2 seconds. The captured images of gestures can be analyzed to obtain gestures contained in the captured image. The obtained gestures can be configured as a gestures password. In at least one embodiment, the gestures password can include, but not limited to, one or more static gestures, duration of each static gestures, motion tail of each static gestures, and chronological order of each static gestures.

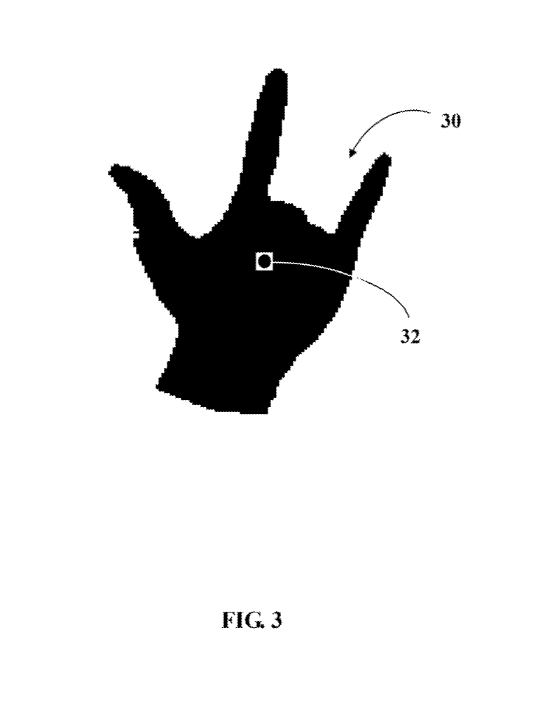

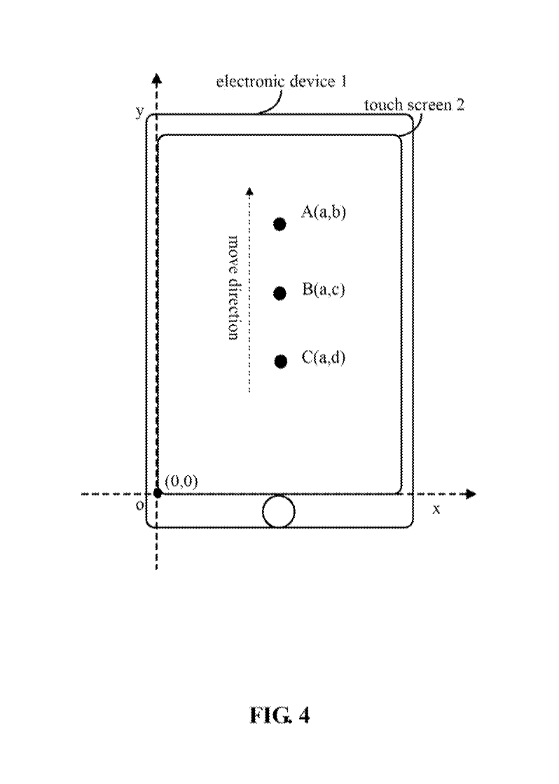

At block 204, the electronic device encrypts the gestures password and then stores the encrypted gestures password into a storage unit. The storage unit 4 can be a storage system, such as a hard disk, a storage card, or a data storage medium. The method for encrypting the gestures can be DES (Data Encryption Standard) or IDEA (International Data Encryption Algorithm). The camera can captures a plurality of gestures images in chronological order. The electronic device then determines whether gestures in adjacent images are substantially same to each other. If the gestures in adjacent images are substantially not same to each other, the electronic device determines that two different static gestures contained in the adjacent images respectively. The electronic device determines motion tail by comparing two or more adjacent images which contain the same gestures. In detail, the electronic device can create a coordinate, for example, a coordinate illustrated in FIG. 4, and then select one or more reference points, for example, reference point 32 on a static gesture 30 illustrated in FIG. 3. The electronic device can obtain motion tail of a static gesture by calculating direction and movement distance of the one or more reference points. For example, referring to FIG. 4, a reference point of a static gesture moves from position “C” to position “A”, the motion tail of the static gesture can be a straight line from position “C” to position “A”.

At block 206, the electronic device detects gestures on a touch screen of the electronic device when the electronic device is in a locked state. In the locked state, the electronic device is powered on and can ignore any user input except “power off”. In at least one embodiment, in the locked state, a locked image is displayed on the display screen, and any information including menus of the electronic devices can be covered by the locked image.

At block 208, the electronic device determines whether the gestures detected are consistent with the gestures password stored in the storage unit. If the detected gestures are substantially consistent with the gestures password stored in the storage unit, the process goes to block 210, otherwise, the process goes back to block 206.

At block 210, the electronic device is unlocked. In the unlock state, the electronic device can detect and response to any user input, for example, contacts on the touch screen.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for unlocking an electronic device, comprising:
configuring, at the electronic device, a gesture password;
storing, at the electronic device, the gesture password;
detecting, at the electronic device, gestures on a touch screen of the electronic device when the electronic device is in a locked state;
determining, at the electronic device, whether the detected gestures are consistent with the gesture password; and
unlocking the electronic device if the detected gestures are consistent with the gesture password.

2. The method according to claim 1, further comprising:
encrypting, at the electronic device, the gesture password.

3. The method according to claim 1, wherein the gesture password comprises one or more time dependent static gestures, duration of each static gesture, and motion tail of each static gesture.

4. The method according to claim 1, wherein detecting gestures on the touch screen are performed within a predetermined time period.

5. The method according to claim 1, wherein detecting gestures on the touch screen comprises:
capturing, at the electronic device, a plurality of time dependent gesture images;
determining, at the electronic device, one or more static gestures contained in the gesture images by comparing an adjacent gesture images;
determining, at the electronic device, a duration of each of the one or more static gestures; and
determining, at the electronic device, a motion tail of each of the one or more static gestures by comparing the adjacent gesture images which contain a same static gesture.

6. An electronic device, comprising:
a touch screen for displaying at least one user interface;
a storage unit for storing instructions;
a processor for executing the instructions to perform a method, the method cause the processor to:
configure a gesture password;
store the gesture password;
detect gestures on a touch screen of the electronic device when the electronic device is in a locked state;
determine whether the detected gestures are consistent with the gesture password; and
unlock the electronic device if the detected gestures are consistent with the gesture password stored in the electronic device.

7. The device according to claim 6, wherein the method further cause the processor to:
encrypt the gesture password.

8. The device according to claim 6, wherein the gesture password comprises one or more time dependent static gestures, duration of each static gesture, and motion tail of each static gesture.

9. The device according to claim 6, wherein the detected gestures occur within a predetermined time period.

10. The device according to claim 6, wherein detecting gestures cause the processor to:
capture a plurality of time dependent gesture images;
determine one or more static gestures contained in the gesture images by comparing an adjacent gesture images;
determine a duration of each of the one or more static gestures; and
determine a motion tail of each of the one or more static gesture by comparing the adjacent gesture images which contain a same static gesture.
